(19) United States
(12) Patent Application Publication
(10) Pub. No.: US 2001/0031023 A1
(43) Pub. Date: Oct. 18, 2001

(54) Method and apparatus for generating pulses from phase shift keying analog waveforms

(76) Inventors: Kin Mun Lye, Singapore (SG); Jurianto Joe, Singapore (SG); Yuen Sam Kwok, Singapore (SG)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/850,713

(22) Filed: May 7, 2001

Related U.S. Application Data
(63) Continuation-in-part of application No. 09/429,527, filed on Oct. 28, 1999, now Pat. No. 6,259,390.

(51) Int. Cl. H04L 27/22

(52) U.S. Cl. 375/329

(57) ABSTRACT

Methods and apparatus for detecting phase shift keying (PSK) signals using circuitry having nonlinear dynamics characteristics are disclosed. A receiver circuit can be implemented using a simple tunnel diode or using an op-amp to provide dynamic characteristics comprising an unstable region bounded by a first and a second stable region. The approach is able to decode one information symbol represented by one cycle of the PSK signal. Performance enhancements by signal clipping and weighted pulse counting method are also disclosed.

### CROSS REFERENCE TO RELATED APPLICATIONS

This application is a continuation-in-part of U.S. application Ser. No. 09/429,527 for METHOD AND APPARATUS FOR GENERATING PULSES FROM ANALOG WAVEFORMS, filed Oct. 28, 1999 which is owned by the Assignee of the present invention.

This application is related to co-pending U.S. application Ser. No. 09/429,519 for A METHOD AND APPARATUS FOR COMMUNICATION USING PULSE DECODING, filed Oct. 28, 1999 and to co-pending and co-owned U.S. application Ser. No. 09/805,854 for METHOD AND APPARATUS TO RECOVER DATA FROM PULSES, filed Mar. 13, 2001, both of which are owned by the Assignee of the present invention and are herein incorporated by reference for all purposes.

### BACKGROUND OF THE INVENTION

This invention relates generally to techniques for generating pulses and more specifically to techniques for converting arbitrary analog waveforms to produce sequences of pulses.

Phase Shift Keying (PSK) is a well-known modulation method in the digital communication community. It has the best performance in an Additive White Gaussian Noise (AWGN) channel as compared to other modulation techniques, such as Frequency Shift Keying (FSK) or On Off Keying (OOK). In the emergence of a pulse decoding communication system (U.S. patent application Ser. No. 09/429,519), it is not obvious as to how to utilize PSK waveforms in a pulse decoding receiver to generate groups of pulses that are convertible to a set of characters or symbols such as binary symbols.

In conventional digital communication system, a coherent detector is used to recover information from a PSK modulated carrier. This detector requires a significant number of carrier cycles to recover one symbol. This means that the carrier frequency must be much higher than the modulating signal.

In a pulse decoding communication system, it is required for the detector to be capable of decoding one cycle of analog waveform to a group of pulses. Consequently, conventional coherent detectors cannot be used in a pulse decoding communication scheme. U.S. patent application Ser. No. 09/429,527 discloses circuit configurations for generating pulses from analog waveforms. These circuits are capable of decoding one cycle of analog waveform to produce a group of pulses. The circuits can be adapted to FSK waveforms because the number of pulses generated by the circuits can differentiate the frequency of each cycle of analog waveform. It is not obvious though how to utilize these circuits so that the groups of pulses generated in response to the PSK waveform can be used to recover the characters or symbols sent by the transmitter. This is due to the fact that PSK carries the information through the phase of the signal while the signal's frequency is the same. Thus, a pulse decoding approach applicable to PSK modulation techniques is needed.

### SUMMARY OF THE INVENTION

A method and apparatus for detecting a received phase shift keying (PSK) signal includes receiving a transmitted PSK signal. In one embodiment of the invention, the transmitted PSK signal is an information waveform representative of one or more symbols to be communicated. The received signal is processed to produce a pulse waveform comprising groups of pulses. A decoder is applied to the groups of pulses to reproduce the original symbols.

A communication system is provided which incorporates the signaling method and apparatus of the present invention.

### BRIEF DESCRIPTION OF THE DRAWINGS

The teachings of the present invention can be readily understood by considering the following detailed description in conjunction with the accompanying drawings:

FIG. 1 shows a simplified circuit diagram of an illustrative embodiment of the present invention;

FIG. 2 are waveforms which explain the operation of the circuit shown in FIG. 1;

FIG. 3 illustrates decoding in accordance with the present invention;

FIG. 4 is a simplified circuit diagram of another illustrative embodiment of the present invention;

FIG. 5 shows decoding in accordance with the embodiment of the invention shown in FIG. 4;

FIG. 6 shows an alternate circuit arrangement for the illustrative circuitry shown in FIG. 1;

FIG. 7 shows a weighted pulse counting approach according to another illustrative embodiment of the invention;

FIG. 8 shows a transfer function of the circuitry used in the present invention;

FIG. 9 shows an illustrative example of a circuit having the transfer function shown in FIG. 8; and

FIG. 10 shows simplified block diagram of a communication system in accordance with the invention.

### DESCRIPTION OF THE SPECIFIC EMBODIMENTS

Non-Coherent Method

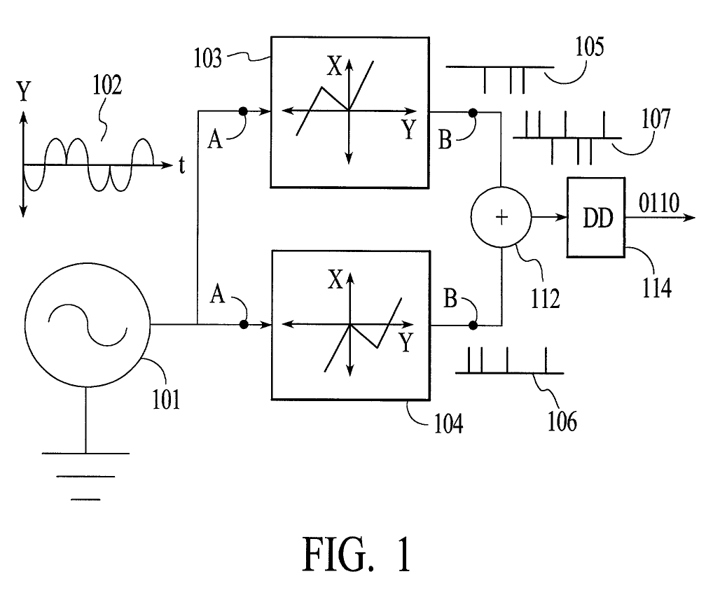

FIG. 1 shows an illustrative example of a particular embodiment of the present invention. A voltage source 101 represents a source of a phase shift keying (PSK) waveform. In a given embodiment of the invention, the voltage source might be the output of a receiver, having received a transmitted PSK-encoded signal. The waveform is shown in FIG. 1 as a sketch 102 illustrating a PSK signal in the time domain.

The PSK signal is fed into circuits 103 and 104, vias inputs A. Each of circuits 103 and 104 has an N-shaped transfer function described by its state variables X and Y. In a particular embodiment, the X and Y variables might be I and V, respectively. Although circuits 103 and 104 both have N-shaped transfer functions, each circuit is configured slightly differently so that they do not respond identically, as will be explained below.

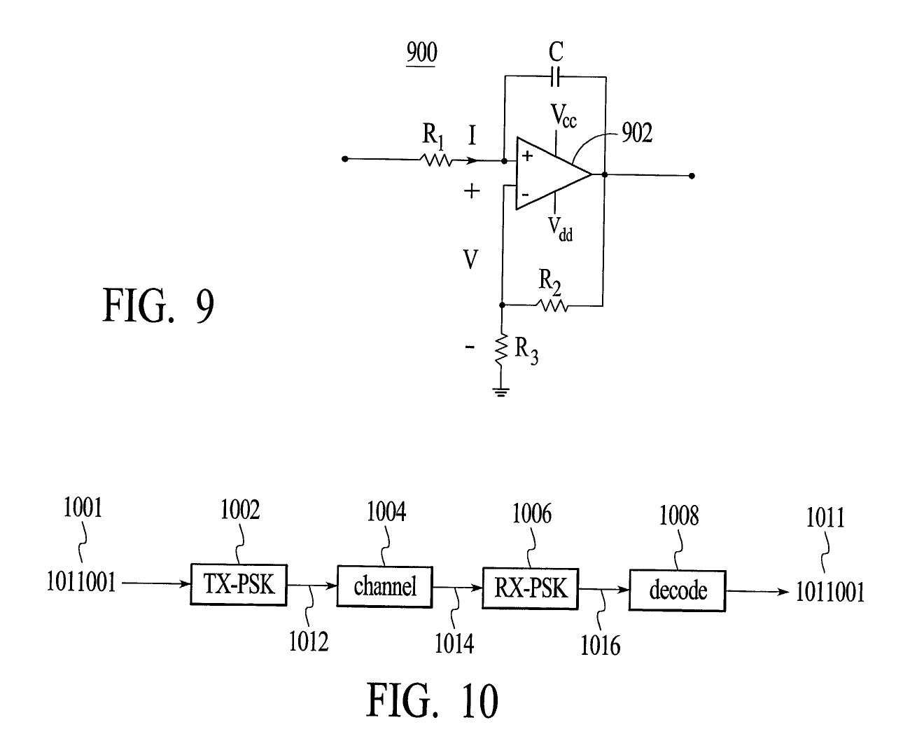

Referring for a moment to FIGS. 8 and 9, an example of a circuit 900 that can be configured to have an N-shaped transfer function 802 is shown. The circuit can be used as the sub-circuits in circuits 103 and 104 . In the circuit example shown in FIG. 9, the circuit 900 is configured around an LM 7121 op-amp 902. A capacitive element C is coupled between the op-amp's output and its positive input. A voltage divider circuit connects the op-amp's output to its negative input. The voltage divider circuit comprises a resistive element R2 and a resistive element R3. An input is coupled through a resistive element R1 to the positive input of the op-amp. The op-amp is biased accordingly via VCC and V_{dd}. Additional circuits are disclosed in co-pending and commonly owned U.S. application Ser. No. 09/429,527, and in U.S. application Ser. No. 09/805,845 which are herein incorporated by reference for all purposes.

Referring to FIG. 8, electronic circuits are typically characterized by their I-V curves, relating the two state variables of current and voltage. For the purposes of the present invention, the “transfer function” of a circuit refers to the relationship between any two state variables of a circuit. Such curves indicate how one state variable (e.g., current) changes as the other state variable (voltage) varies. According to the invention, the circuit 900 is configured so that its transfer function 802 includes a portion which lies within a region 804, referred to herein as an “unstable” region. For the transfer function shown, the unstable region is bounded on either side by regions 806 and 808, each of which is herein referred to as a “stable” region.

A circuit in accordance with the invention has an associated “operating point,” which is defined as its location on the transfer function 802. The nature of the output of the circuit 900 depends on the location of its operating point. If the operating point is positioned along the portion of the transfer function that lies within region 804, the output of the circuit will exhibit an oscillatory behavior. Hence, the region 804 in which this portion of the transfer function is found is referred to as an unstable region. If the operating point is positioned along the portions of the transfer function that lie within either of regions 806 and 808, the output of the circuit will exhibit a generally time-varying but otherwise non-oscillatory behavior. For this reason, regions 806 and 808 are referred to as stable regions.

Such behavior in the circuit 900 is referred to as a “controlled” relaxation oscillation. In the context of the present invention, the term “controlled relaxation oscillations” refers to the operation of circuitry in such a way that a number of desired oscillations can be generated followed by a substantially instantaneous termination of the oscillations. Conversely, the circuit is able to respond, substantially without transients, from a non-oscillatory condition to an oscillatory state to yield a desired number of oscillations.

U.S. application Ser. No. 09/429,527 discloses additional circuits for achieving controlled relaxation oscillations. U.S. application Ser. No. 09/805,824 discloses circuitry also having controlled relaxation oscillations, but further being characterized by having resistive input impedances.

Referring to FIG. 1 and FIG. 9, an example of sub-circuit 103 in the particular illustrated embodiment shown is configured with the following component values: V_{cc}=1 V, V_{dd}=−3.5 V, R1=680 Ω, R2=68 Ω, R3=10 Ω, and C=68 nF. The op-amp used is an LM7121. In this particular case, X and Y corresponds to I and V, respectively. As configured, the unstable region is located in the plane defined by Y<0, as indicated by the graphic shown in circuit 103. In addition, the output of circuit 103 will comprise negative-going pulses.

Similarly, an example of sub-circuit 104 is configured with the same component values as that of sub-circuit 103. Only the op-amp DC biasing differs. In this case, V_{cc}=3.5 V, V_{dd}=−1 V. As configured, the unstable region is located in the plane defined by Y>0, as indicated by the graphic shown in circuit 104. The circuit produces positive-going pulses.

When the amplitude of Y at the input A of circuit 104 is positive, its output B will comprise groups of pulses, while the output B of circuit 103 will be substantially non-oscillatory. Conversely, when the amplitude of Y is negative, the output B of circuit 104 will be non-oscillatory, while circuit 103 will generate groups of negative-going pulses at it output B. The resulting sequence of pulses 105 and 106 so produced can be added by a summing device 112 to produce a combined sequence of pulses 107.

As can be seen in the figure, the sequence of pulses 107 comprise positive- and negative-going pulses, which are then fed into a decision device 114. The decision device might be a simple pulse counter. In a particular illustrative embodiment, for example, a pulse counter might count the positive-going pulses to produce a first pulse count. Next, the pulse counter counts the negative-going pulses to produce a second pulse count. A symbol based on the first and second pulse counts are then identified, for example, by mapping the count value to a symbol. This is repeated to produce a sequence of symbols.

In an alternate configuration, the outputs B of the circuits 103 and 104 might be fed directly to the decision device 114. In this configuration, the decision device maps the pulses in a similar manner as discussed above to produces a sequence of symbols. For example, a pulse counting method might be used.

Additional pulse decoding techniques are disclosed in U.S. application Ser. No. 09/805,854.

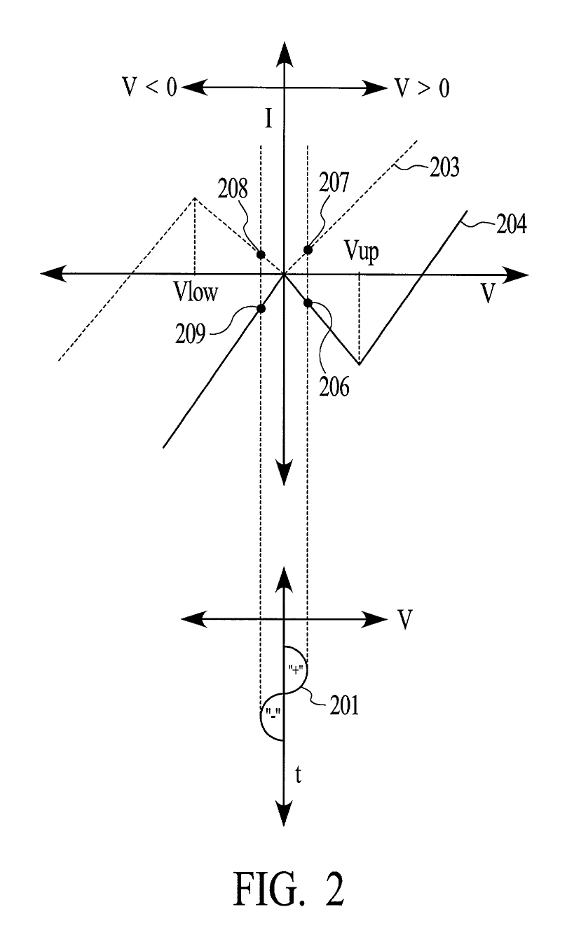

FIG. 2 shows the circuit operation of circuits 103 and 104 of FIG. 1. The figure illustrates a particular example of the transfer functions for circuits 103 and 104. For these circuits, the state variables are I and V. The I-V characteristic of circuit 103 and 104 are the N-shaped transfer functions 203 and 204, respectively. Note that the unstable region of transfer function 203 lies in the plane defined by 0>V>V_{low}. The unstable region of transfer function 204 lies in the plane defined by 0<V<Vᵤₚ.

An analog waveform 201 is shown, representative of a PSK signal; for example, a received PSK-modulated information signal in a PSK-based communication system. The analog signal is shown in the figure in a rotated orientation to illustrate its relationship with the transfer functions 203, 204.

When the amplitude of the wavefonn is positive (i.e., greater than zero), it can be seen that the operating point of the circuit 104 lies in the unstable region of its transfer function 204. FIG. 2 shows the operating point at the peak of the positive swing of the waveform 201, showing its location to be 206 on its transfer function. Since the operating point is located in the unstable region, the circuit 104 is in an oscillatory condition and will produce pulses at its output.

Conversely, the operating point of the circuit 103 is shown to be at location 207 on its transfer function 203, during the peak positive swing of the waveform 201. This location on the transfer function 203 lies outside of the unstable region, and so the output of the circuit 103 will be a generally time-varying but non-oscillatory output at the positive peak of the analog waveform 201. Moreover, during the entire positive-going portion of the waveform 201, the operating point of the circuit 103 lies in a stable region of its transfer function 203.

When the amplitude of analog waveform 201 is less than zero (i.e., negative), the operating point of the circuit 104 is moved to a stable operating region of the transfer curve 204. Consequently, the output is a generally time-varying but otherwise non-oscillatory signal. FIG. 2 shows that the negative peak of the analog waveform 201 forces the operating point of the circuit 104 to location 209 of the transfer function.

As can be seen from FIG. 2, the operating point for the circuit 103 lies in the unstable operating region of its transfer function 203 during the negative-going portion of the analog waveform 201. FIG. 2 shows that at the negative peak of the waveform 201, the operating point of the circuit 103 is at location 208. Its output, therefore, will be oscillatory and in the form of pulses.

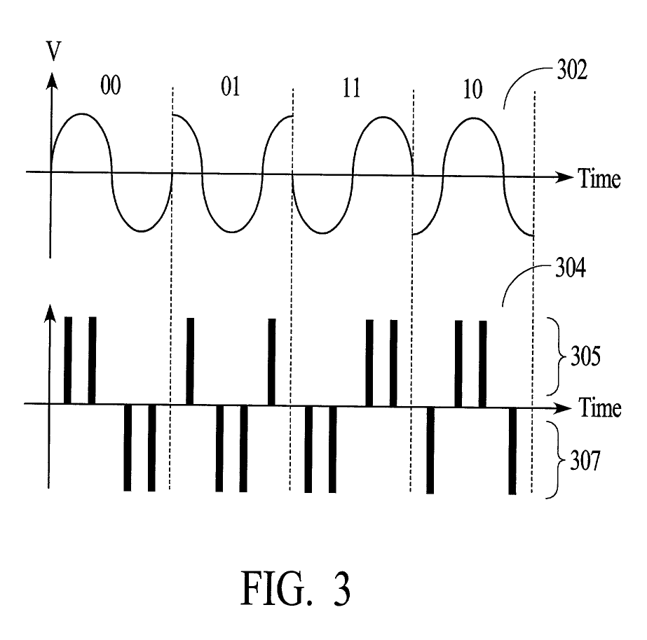

FIG. 3 shows an illustrative embodiment of the present invention using a form of PSK known as quaternary phase shift keying (QPSK). The circuit configuration of FIG. 1 is used to explain the operation of the invention using QPSK waveforms.

In a QPSK analog waveform, each cycle of the analog waveform carries two bits of information. Thus, for example, waveform 302 comprises four cycles of analog waveforms that represent bits 00, 01, 11 and 10. Suppose waveform 302 is applied as an input to the circuit configuration shown in FIG. 1. Based on the transfer functions shown in FIG. 2, the responses to one-cycle waveforms 302 include the groups of pulses 304, one group of pulses for each of the four cycles. The positive-going pulses 305 are produced by circuit 104, while the negative-going pulses are produced by circuit 103.

As can be seen in FIG. 3, the positive- and negative-going pulses do not overlap in time. This is due to the exclusive nature of the pulse-generating behavior of the circuits 103, 104 which can be seen in FIG. 2. Consequently, the outputs of circuits 103 and 104 can be summed (as shown in FIG. 1 by summer 112) without corrupting either output. In the illustrative example shown in FIG. 3, the four unique single-cycle QPSK waveforms produce correspondingly unique combinations of groups of pulses. These pulses can be decoded by the decision device 114 using conventional pulse detection techniques. U.S. application Ser. No. 09/805,854 discloses various alternative techniques as well.

Coherent Method

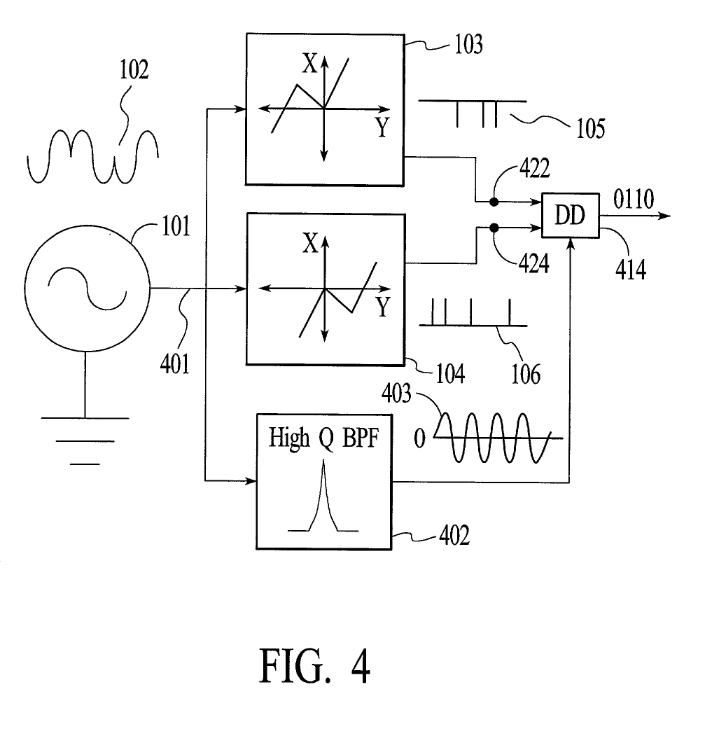

Refer now to FIG. 4 for an illustrative example of another embodiment of the present invention, hereinafter referred to as the coherent method. FIG. 4 shows a circuit configuration similar to that of FIG. 1. The same reference numerals are used where the components disclosed in FIG. 1 are also shown in FIG. 4. A PSK source signal 401 is represented by generator 101. The PSK signal feeds into first and second pulse generating circuits 103 and 104. A decision device 414 receives the outputs directly from the circuits 103 and 104. A high-Q bandpass filter (BPF) 402 receives the PSK signal 401. An output 403 of the filter serves as a synchronization signal that feeds into the decision device.

According to this particular illustrative embodiment of the invention, the center frequency of the high-Q bandpass filter 402 is set to the frequency (F). This is the frequency of the sinusoidal waveform used to generate each cycle of the PSK signal. The frequency spectrum of the PSK signal 401 includes a frequency component of frequency F which can be extracted by applying the signal to the frequency-selective high-Q filter 402. The output is a sine wave 403 of frequency F, absent phase variations. Thus, each cycle of the sinusoidal signal 403 corresponds to one cycle of the PSK signal. The signal 403 is fed into the decision device 414 and serves to synchronize a clock in the decision device with the incoming PSK signal 401.

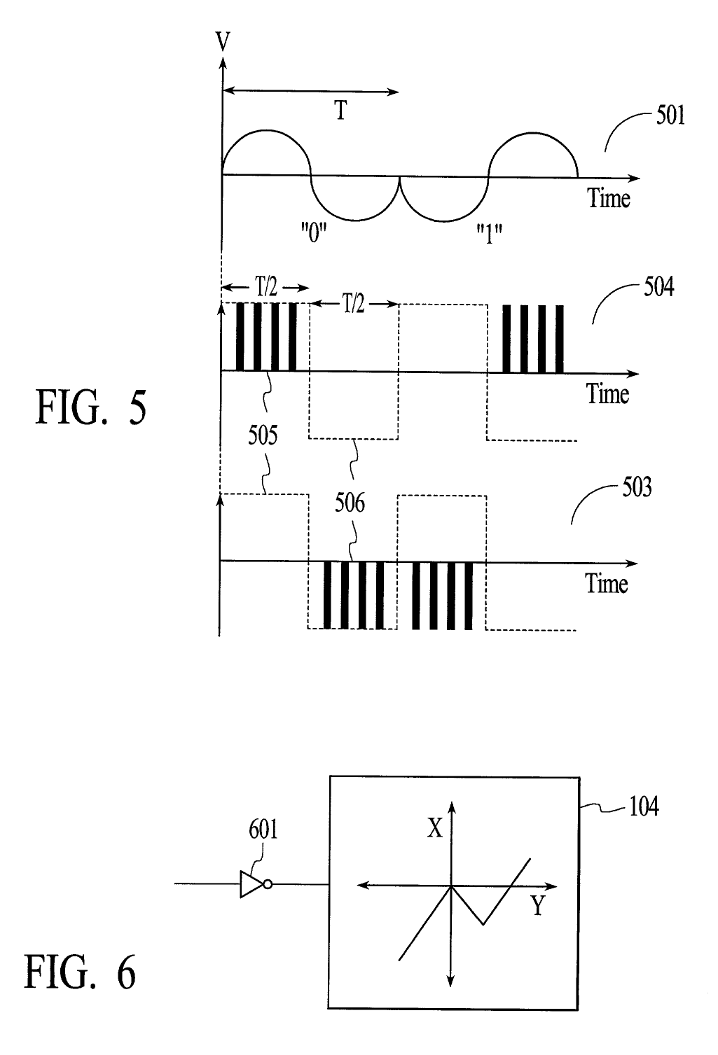

FIGS. 4 and 5 illustrate how the decision device 414 performs decoding on the groups of pulses received from circuits 103 and 104, using the synchronization signal 403. The synchronization signal controls pulse counting circuitry (not shown) in the decision device to detect and count the positive-going pulses and the negative-going pulses received by the decision device. The positive cycle of the synchronization pulse enables the detection and counting of any positive pulses, while the negative cycle of the synchronization pulse enables the detection and counting of any negative pulses.

To simplify the discussion without loss of generality, the PSK waveform 501 shown in FIG. 5 is a binary PSK (BPSK) signal. The waveform represents the binary symbols “0” and “1”. In the example shown, the sinusoidal waveform has a period

$$T = \frac{1}{F} .$$

Waveforms 503 and 504 comprise groups of pulses generated by circuits 103 and 104, respectively, in response to the BPSK input waveform 501.

To decide what symbol is transmitted, four pulse counters (not shown) are utilized. For a symbol with period T, two counters are provided to count the number of positive-going pulses 505 generated during the first half of the period (T/2). These counters are enabled during a positive cycle of the synchronization signal 403. One counter is configured to count the positive-going pulses in waveform 503 and another counter is configured to count the positive-going pulses in waveform 504.

The negative pulses are counted in a similar manner. Another two counters are provided to count the number of negative-going pulses 506 generated during the second half of the period. These counters are enabled during a negative cycle of the synchronization signal 403. Again, one counter is configured to count the negative-going pulses in waveform 503 and another counter is configured to count the negative-going pulses in waveform 504.

Let the results of the counts from the first two counters be denoted by N1 and N2. For example, N1 might represent the positive-going pulse count from waveform 503 while N2 represents the positive-going pulse count of waveform 504, both obtained during the first half of the period. During the second half period, the second two counters count the number of negative-going pulses contained in waveforms 503 and 504, where a count N3 represents the negative-going pulse count of waveform 503 and N4 represents the negative-going pulse count of waveform 504.

Based on the counts N1, N2, N3 and N4 during the period T, a decision can be made as to the symbol represented. For example, to decide whether bit “0” or bit “1” is recovered, the following decision function d might be used:

d=sgn(N)=sgn(N1−N3+N4−N2),

$$where sgn ( N ) = \{ \begin{matrix}+ 1 , & N > 0 \\ 0 , & N = 0 \\ - 1 , & N < 0.\end{matrix}$$

Bit “0” will be assigned when d=1 and bit “1” will be assigned when d=−1. When d=0, an indeterminate condition exists whereby a decision cannot be made. In such a case, the decision might be made on a random basis, or be consistently assigned to either bit “0” or “1”.

The following variations of the above illustrative embodiments can be applied to both coherent and non-coherent method. The first variation is an alternative circuit configuration for detecting PSK signals. The second and third variations disclose a method to enhance the performance of the receiver under AWGN-characterized channel.

1. Alternative Circuit Configuration

Consider FIGS. 1 and 6. It is possible to detect PSK signals using either two occurrences of circuit 103, or two occurrences of circuit 104. This alternative configuration allows one to design a circuit with an identical transfer function. There is an additional component to be added if such configuration is desired. For example, in order to use two occurrences of circuit 104 for PSK signal detection, an inverter 601 must be used as a front-end element of one of the duplicate circuits 104. Such a modified circuit can the replace circuit 103 shown in FIG. 1. The receiver configuration FIG. 1 now consists of two identical circuits 104.

2. Signal Clipping

Refer now to FIGS. 1 and 2. It can be seen that circuit 104 will generate pulses in response to upper half (positive cycle) of the analog waveform 201 so long as the peak amplitude of the waveform is less than Vᵤₚ. Similarly, circuit 103 will generate pulses in response to lower half of the sinusoidal waveform so long as the negative peak amplitude of the waveform 201 is greater than V_{low}.

Under ideal conditions, waveform 201 would be bounded by V_{low} and Vᵤₚ. However, conditions are seldom ideal. In a noisy environment, it is possible that the positive and negative peak amplitudes of the waveform 201 will exceed the V_{low} and Vᵤₚ limits. When that happens, the operating point is moved to the stable region. Hence, no pulses are generated during this time. If the decoding method relies on pulse counting, then there will be an error in recovering the symbol.

One way to prevent the operating point from being moved out of unstable region is to clip the waveform 201. Thus, for the upper half portion, the positive peak amplitude might be clipped at a voltage less than Vᵤₚ. Similarly, for the lower half portion, the negative peak amplitude might be clipped at a voltage less than V_{low}. This can be achieved with the use of conventional voltage clamping circuits.

3. Weighted Pulse Counting Algorithm

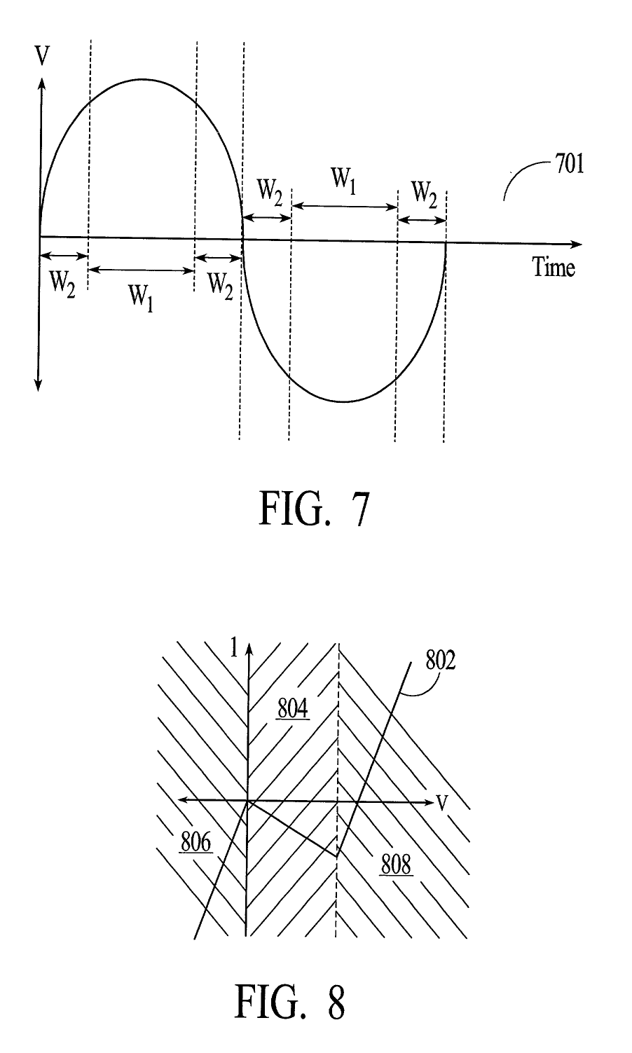

As shown in FIG. 5, bit “0” and bit “1” are represented by the same sinusoidal waveform with 180 degrees phase difference in the two-level (binary) PSK signals (BPSK). In the presence of noise, these sinusoidal waveforms 501 might become distorted. The sinusoidal waveform used in PSK system is reproduced in FIG. 7. Sinusoidal waveform 701 is dissected into portions W1 and W2. The portions W2 represent parts of the waveform that are easily distorted by noise because they contain less energy. On the other hand, the portions W1 represent parts of the sinusoidal that are less susceptible to noise because they have more energy and thus are more robust. Therefore, it is reasonable in a counting algorithm used in the decision device to put more weight to pulses generated during portions W2 and less weight to pulses generated during portions W1. By weighting the pulse count, the performance of the detector increases. For example, the number of pulses counted during the W1 portions might be multiplied by a factor greater than one. The “weighted” count can then be added to the number of pulses counted in portions W2.

Referring to FIG. 10, an illustrative example of a particular embodiment of a communication system according to the present invention is disclosed. The communication system includes a transmitting location 1002. Information 1001 to be transmitted is provided to the transmitting location. Though the figure shows that the information 1001 comprises binary symbols, it is understood that the information symbols are not limited to binary symbols. The information is used to modulate a carrier signal in accordance with a PSK signalling method; e.g., binary PSK, or quaternary PSK, and the like. A PSK signal 1012 is produced.

The PSK signal 1012 is transmitted over a channel, schematically represented by the box labelled 1004. The channel may be any medium, wired or wireless, over which a PSK signal can be transmitted. A transmitted PSK signal 1014 is received at a receiving location 1006. The receiving location includes, among others, circuitry disclosed herein for producing group of pulses at it's output., generically shown as output 1016. The groups of pulses are then decoded by a decoder 1008, e.g., by counting pulses, to produce symbols 1011 which represent a recovery of the orginal information 1001.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Although the present invention has been described in terms of specific embodiments, it should be apparent to those skilled in the art that the scope of the present invention is not limited to the described specific embodiments.

Further, while the present invention has been described using a particular combination of hardware and software, it should be recognized that other combinations of hardware and software are also within the scope of the present invention. The present invention may be implemented only in hardware or only in software or using combinations thereof, depending on performance goals and other criteria not relevant to the invention.

The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1. A method for detecting a phase shift keying (PSK) signal comprising:
for each cycle of said PSK signal (i) producing a first group of one or more pulses based on a positive portion of said cycle and (ii) producing a second group of one or more pulses based on a negative portion of said cycle; and
producing an information symbol on the basis of said first and second groups of one or more pulses.

2. The method of claim 1 further including providing a first circuit configured to produce said first group of one or more pulses in response to detecting said positive portion of said cycle and providing a second circuit configured to produce said second group of one or more pulses in response to detecting said negative portion of said cycle.

3. The method of claim 2 wherein said first and second circuits each has a transfer function characterized by having an unstable region bounded by stable regions.

4. The method of claim 1 wherein said producing an information symbol includes counting pulses in said first and second groups of one or more pulses to respectively produce first and second pulse counts, said information being produced based on said pulse counts.

5. The method of claim 4 wherein said counting includes weighting the contribution of said pulses to a pulse count depending on which portion of said PSK signal said pulses were produced.

6. The method of claim 4 wherein for said first group of one or more pulses, some of said pulses contribute more than one count to said first pulse count.

7. The method of claim 1 wherein said producing a first group of one or more pulses includes limiting a maximum positive amplitude of said positive portion of said cycle to a first value.

8. The method of claim 7 wherein said limiting is a step of clamping said PSK signal.

9. The method of claim 1 wherein said first group of one or more pulses are positive-going pulses and said second group of one or more pulses are negative-going pulses.

10. The method of claim 1 further including combining said first and second groups of one or more pulses prior to said producing an information symbol.

11. The method of claim 1 further including producing a synchronization signal from said PSK signal, said producing an information signal including detecting said first group of one or more pulses and said second group of one or more pulses based on said synchronization signal.

12. The method of claim 11 wherein said synchronization signal is a sinusoidal signal having a frequency substantially equal to the frequency of a sinusoidal waveform used to represent a PSK symbol.

13. The method of claim 1 wherein said PSK signal is a binary phase shift keying (BPSK) signal.

14. The method of claim 1 wherein said PSK signal is a quaternary phase shift keying (QPSK) signal.

15. The method of claim 1 further including receiving a transmitted signal and producing said PSK signal from said transmitted signal.

16. In a phase shift keying (PSK) signal, a method for recovering information therefrom comprising:
receiving a transmission of said PSK signal;
producing a plurality of groups of one or more pulses from said PSK signal; and
producing a plurality of symbols based on said groups of one or more pulses, said information comprising said symbols.

17. The method of claim 16 wherein said producing includes applying said PSK signal to a first circuit to produce first groups of pulses and applying said PSK signal to a second circuit to produce second groups of pulses, said first and second circuits each characterized by a transfer function having an unstable operating region bounded by a first stable operating region and a second stable operating region.

18. The method of claim 17 wherein said first circuit is responsive to positive amplitudes of said PSK signal to produce said first groups of pulses, and said second circuit is responsive to negative amplitudes of said PSK signal to produce said second groups of pulses.

19. The method of claim 17 wherein said first groups of pulses are positive-going pulses and said second groups of pulses are negative-going pulses.

20. The method of claim 16 wherein said producing a plurality of symbols includes counting pulses in said groups of pulses to produce a pulse count for each group of pulses, said symbols being determined based on said pulse counts.

21. The method of claim 20 wherein said counting pulses in said groups of pulses includes weighting the contribution of said pulses to said pulse count depending on which portions of said PSK signal said pulses were produced.

22. The method of claim 20 wherein for each pulse count some pulses in its corresponding group of pulses contribute more than one count to said pulse count.

23. The method of claim 16 further including a voltage clamp configured to limit a maximum positive peak amplitude of said PSK signal to a first value.

24. The method of claim 23 wherein said voltage clamp is further configured to limit a minimum negative peak amplitude of said PSK signal to a second value.

25. The method of claim 16 wherein said PSK signal is a binary PSK signal or a quaternary PSK signal.

26. The method of claim 16 further including producing a synchronization signal from said PSK signal, said producing a plurality of groups of one or more pulses being based on said synchronization signal.

27. The method of claim 16 wherein said groups of one or more pulses comprise positive-going pulses and negative-going pulses.

28. The method of claim 16 further including receiving said information and modulating a carrier wave with said information to produce said PSK signal, and transmitting said PSK signal.

29. A circuit system for detecting a phase shift keying (PSK) signal comprising:
a first circuit configured to produce a plurality of groups of one or more positive pulses in response to detecting first portions of said PSK signal;
a second circuit configured to produce a plurality of groups of one or more negative pulses in response to detecting second portions of said PSK signal; and
a decoder configured to produce a plurality of information symbols based on said groups of positive and negative pulses.

30. The circuit system of claim 29 wherein said first circuit and said second circuit each has an associated transfer curve characterized by having an unstable region bounded by first and second unstable regions.

31. The circuit system of claim 29 wherein said first portions of said PSK signal are positive amplitude portions of said PSK signal and said second portions of said PSK signal are negative amplitude portions of said PSK signal.

32. The circuit system of claim 29 further including a summing circuit coupled to said first and second circuits and configured to sum said groups of positive and negative pulses.

33. The circuit system of claim 29 wherein said decoder is further configured to produce first pulse counts from said positive pulses and second pulse counts from said negative pulses, said pulse counts being used to produce said information symbols.

34. The circuit system of claim 33 wherein for each pulse count, some of its constituent pulses are weighted more heavily than others of said constituent pulses.

35. The circuit system of claim 29 further including a signal source coupled to receive said PSK signal and configured to produce a synchronization signal therefrom, said synchronization signal being operatively coupled to said decoder to detect said groups of positive pulses and said groups of negative pulses.

36. The circuit system of claim 35 wherein said signal source is a bandpass filter tuned to a frequency substantially equal to the frequency of said PSK signal.

37. The circuit system of claim 29 wherein said PSK signal is a binary PSK signal.

38. The circuit system of claim 29 wherein said PSK signal is a quaternary PSK signal.

39. The circuit system of claim 29 further comprising a receiver circuit configured to receive a transmitted signal comprising said PSK signal.

40. The circuit system of claim 29 incorporated in a PSK-based communication system.

41. A phase shift keying (PSK) detection system comprising:
means for receiving a transmitted PSK signal;
first means for producing a plurality of positive pulses from said received signal;
second means for producing a plurality of negative pulses from said received signal; and
symbol means for producing information symbols from said positive and negative pulses.

42. The detection system of claim 41 wherein said first and second means each comprises a circuit having a transfer function characterized by having an unstable operating region bounded by first and second stable operating regions.

43. The detection system of claim 42 wherein said circuit of said first means is configured to respond to positive amplitude portions of said PSK signal, and said circuit of said second means is configured to respond to negative amplitude portions of said PSK signal.

44. The detection system of claim 42 further including limit means coupled to receive said transmitted PSK signal for limiting maximum peak positive amplitudes and minimum peak negative amplitudes of said transmitted PSK signal.

45. The detection system of claim 41 further including means, coupled to said symbol means, for producing a synchronization signal based on said PSK signal, said symbol means producing said information symbols from said positive pulses and from said negative pulses depending on said synchronization signal.
